(19) United States
(12) Patent Application Publication
(10) Pub. No.: US 2025/0140870 A1
(43) Pub. Date: May 1, 2025

(54) BATTERY AND METHOD FOR PRODUCING BATTERY

(71) Applicants: TOYOTA JIDOSHA KABUSHIKI KAISHA, Toyota-shi (JP); AISAN KOGYO KABUSHIKI KAISHA, Obu-shi (JP)

(72) Inventors: Hideaki NISHIMURA, Sunto-gun (JP); Fuminori MIZUNO, Miyoshi-shi (JP); Tetsuya WASEDA, Susono-shi (JP); Masatsugu KAWAKAMI, Sunto-gun (JP); Takuya MATSUYAMA, Miyoshi-shi (JP); Kento MASUMURA, Nagakute-shi (JP); Tomotaka SUZUKI, Okazaki-shi (JP); Tsuneyuki YOKOCHI, Nagoya-shi (JP); Yukihiro NAKABAYASHI, Obu-shi (JP); Katsuhiko MAKINO, Chita-gun (JP); Masaki KAGA, Nagoya-shi (JP); Tomoyuki TAKEMOTO, Nagoya-shi (JP)

(73) Assignees: TOYOTA JIDOSHA KABUSHIKI KAISHA, Toyota-shi (JP); AISAN KOGYO KABUSHIKI KAISHA, Obu-shi (JP)

(21) Appl. No.: 18/910,297

(22) Filed: Oct. 9, 2024

(30) Foreign Application Priority Data
Oct. 26, 2023 (JP) 2023-184055

(51) Int. Cl. H01M 4/66; H01M 4/04; H01M 4/38; H01M 4/583

(52) U.S. Cl. CPC H01M 4/668; H01M 4/0404; H01M 4/386; H01M 4/583; H01M 4/661

(57) ABSTRACT

A main object of the present disclosure is to provide a battery of which degrade in discharge properties caused by an anode current collector (Al current collector) is inhibited. The present disclosure achieves the object by providing a battery including a cathode, an anode, and an electrolyte layer arranged between the cathode and the anode, wherein the anode includes an anode current collector that is an Al current collector, and an anode active material layer containing an anode active material of which reaction potential is lower than that of Al; and the anode current collector is covered with a resin coating layer containing a resin and a conductive material, and further, an intermediate layer containing the resin and the anode active material is arranged between the resin coating layer and the anode active material layer.

### TECHNICAL FIELD

The present disclosure relates to a battery, and a method for producing a battery.

### BACKGROUND ART

In accordance with the rapid spread of information-related apparatuses and communication devices such as a personal computer and a portable telephone in recent years, the development of a battery used for the power source thereof has been advanced. Also, in the automobile industry, the development of a battery used for hybrid electric vehicles (HEV), plug-in hybrid electric vehicles (PHEV), or battery electric vehicles (BEV) has been advanced.

For example, Patent Literature 1 discloses an anode for all solid state battery including an anode current collecting layer and an anode active material layer, wherein the anode current collecting layer is an aluminum foil or an aluminum alloy foil.

### CITATION LIST

### Patent Literature

Patent Literature 1: Japanese Patent Application Laid-Open (JP-A) No. 2022-085523

### SUMMARY OF DISCLOSURE

### Technical Problem

From the view point of improving the energy density by decreasing the weight of the battery, and from the view point of inhibiting the deterioration of battery by improving the heat dissipation of the battery, usage of Al (aluminum) as a material of the anode current collector is presumed. Meanwhile, since the reaction potential of Al is comparatively high, when a material of which reaction potential is lower than that of Al is used as the anode active material, the anode current collector (Al current collector) reacts with Li ions faster than the anode active material, which easily degrades the discharge properties.

The present disclosure has been made in view of the above circumstances, and a main object thereof is to provide a battery of which degrade in discharge properties caused by an anode current collector (Al current collector) is inhibited.

### Solution to Problem

[1]

A battery comprising a cathode, an anode, and an electrolyte layer arranged between the cathode and the anode, wherein the anode includes an anode current collector that is an Al current collector, and an anode active material layer containing an anode active material of which reaction potential is lower than the reaction potential of Al; and the anode current collector is covered with a resin coating layer containing a resin and a conductive material, and further, an intermediate layer containing the resin and the anode active material is arranged between the resin coating layer and the anode active material layer.

[2]

A battery comprising a cathode, an anode, and an electrolyte layer arranged between the cathode and the anode, wherein the anode includes an anode current collector that is an Al current collector, and an anode active material layer containing an anode active material of which reaction potential is lower than the reaction potential of Al; and the anode active material layer is a layer containing a resin, and is a concentration gradient layer of which concentration of the resin increases from the electrolyte layer towards the anode current collector side.

[3]

The battery according to [1] or [2], wherein the resin is a thermoplastic resin.

[4]

The battery according to any one of [1] to [3], wherein a reaction potential of the anode active material is 0.3 V (Li⁺/Li) or less.

[5]

The battery according to any one of [1] to [4], comprising a Si-based active material or a carbon-based active material as the anode active material.

[6]

The battery according to [5], comprising the Si-based active material as the anode active material.

[7]

The battery according to any one of [1] to [6], wherein the electrolyte layer is a solid electrolyte layer containing a solid electrolyte.

[8]

The battery according to [1], wherein the resin coating layer does not contain the anode active material.

[9]

The battery according to [1], wherein a rate of a thickness of the intermediate layer with respect to a total thickness of the anode active material layer, the intermediate layer and the resin coating layer is 0.80% or more.

[10]

The battery according to [1] or [9], wherein a rate of a thickness of the intermediate layer with respect to a total thickness of the anode active material layer, the intermediate layer and the resin coating layer is 7.0% or less.

[11]

The battery according to [1], wherein a thickness of the resin coating layer is 10 μm or less.

[12]

A method for producing the battery according to [1], the method comprising: a layered body forming step of obtaining a layered body including layers in the order of the Al current collector, the resin coating layer, and the anode active material layer in a thickness direction; and a pressing step of applying a pressing pressure to the layered body in the thickness direction to form the intermediate layer.

[13]

The method for producing the battery according to [2], the method comprising a concentration gradient layer forming step of forming the concentration gradient layer on one surface of the Al current collector in a thickness direction.

### Advantageous Effects of Disclosure

The present disclosure exhibits an effect of inhibiting degrade in discharge properties caused by an anode current collector (Al current collector).

### BRIEF DESCRIPTION OF DRAWINGS

FIGS. 1A and 1B are schematic cross-sectional views exemplifying the battery in the present disclosure.

FIG. 2 is a schematic cross-sectional view exemplifying the battery in the present disclosure.

### DESCRIPTION OF EMBODIMENTS

The battery, and the method for producing the battery in the present disclosure will be hereinafter explained in details. Each drawing described as below is a schematic view, and the size and the shape of each portion are appropriately exaggerated in order to be understood easily. Furthermore, in the present description, upon expressing an embodiment of arranging one member with respect to the other member, when it is expressed simply “on” or “below”, both of when the other member is directly arranged on or below the one member so as to contact with each other, and when the other member is arranged above or below the one member interposing an additional member, can be included unless otherwise described.

### A. Battery

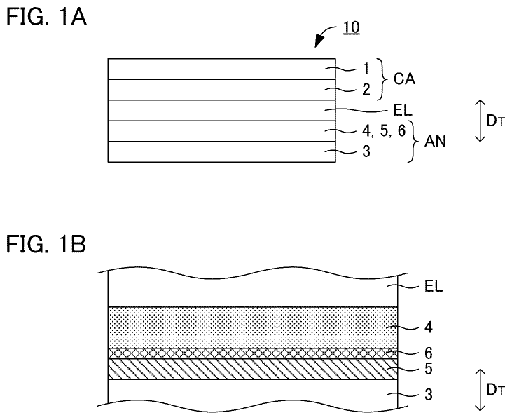

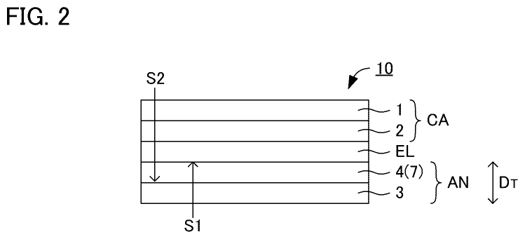

FIG. 1A is a schematic cross-sectional view exemplifying the battery in the present disclosure, and FIG. 1B is an enlarged view of a part of FIG. 1A. Also, FIG. 2 is a schematic cross-sectional view exemplifying the battery in the present disclosure. As shown in FIGS. 1A, 1B, and FIG. 2, battery 10 in the present disclosure includes cathode CA, anode AN, and electrolyte layer EL arranged between the cathode CA and the anode AN in thickness direction D_{T}. As shown in FIGS. 1A, 1B, and FIG. 2, the cathode CA usually includes cathode current collector 1 and cathode active material layer 2. Also, the anode AN includes anode current collector 3 that is an Al current collector, and anode active material layer 4 containing an anode active material of which reaction potential is lower than that of Al.

As shown in FIG. 1B, the anode current collector 3 may be covered with resin coating layer 5 containing a resin and a conductive material. Further, in the anode AN, intermediate layer 6 containing the resin and the anode active material may be arranged between the resin coating layer 5 and the anode active material layer 4. Meanwhile, as shown in FIG. 2, the anode active material layer 4 may be a layer containing a resin, and may be concentration gradient layer 7, of which concentration of the resin increases from the electrolyte layer EL towards the anode current collector 3 side.

According to the present disclosure, since the anode includes the anode active material layer, the intermediate layer and the resin coating layer, or since the anode active material layer in the anode is the concentration gradient layer, the intermediate layer or the concentration gradient layer supports the physical adhesiveness in the interface of the anode active material layer and the resin coating layer, and supports the conductivity thereof, as well as contributes to decrease the electric resistance in the interface, and thus the degrade in discharge properties caused by the anode current collector (Al current collector) is inhibited in the battery.

As described above, from the view point of improving the energy density by decreasing the weight of the battery, and from the view point of inhibiting the deterioration of the battery by improving the heat dissipation of the battery, usage of Al (aluminum) as a material of the anode current collector is presumed. Meanwhile, since the reaction potential of Al is comparatively high, when a material of which reaction potential is lower than that of Al is used as the anode active material, the anode current collector (Al current collector) reacts with Li ions and is alloyed faster than the anode active material. The discharge properties are easily degraded by the damage of the current collector due to the alloying.

In contrast, as shown in FIGS. 1A and 1B, in the battery 10 wherein the anode AN includes the anode active material layer 4, the intermediate layer 6, and the resin coating layer 5, the resin included in the intermediate layer 6 and the resin included in the resin coating layer form a structure in which the electrolyte layer EL that is a moving path of Li ion does not directly contact the anode current collector 3. The moving path of Li ions is blocked by the intermediate layer 6 and the resin coating layer 5, and thus it is possible to prevent the Li ions from moving to the anode current collector 3. Even in the potential range where the Li ions react with the anode current collector 3 (Al current collector) to be alloyed with lithium, since Li ions are not present near the surface of the anode current collector 3 (Al current collector), the damage of the current collecting foil due to the alloying of the anode current collector 3 (Al current collector) does not occur. As a result, the degrade in discharge properties caused by the anode current collector 3 (Al current collector) can be inhibited. Also, by arranging the intermediate layer 6, the adhesion of the anode active material layer 4 and the resin coating layer 5 is improved by an anchor effect. Thereby, the discharge properties improve.

Meanwhile, as shown in FIG. 2, in the battery 10 wherein the anode active material layer 4 is the concentration gradient layer 7, since the proportion of the resin increases towards the anode current collector 3 in the concentration gradient layer 7, similarly to the above, the structure in which the electrolyte layer EL that is the moving path of Li ions does not directly contact the anode current collector 3, is formed, and thus it is possible to prevent Li ions from moving to the anode current collector 3. As a result, the degrade in discharge properties caused by the anode current collector 3 (Al current collector) can be inhibited.

Also, when Li ions are present near the surface of Al, alloying reaction with lithium occurs at a comparatively high potential (+0.3 V vs Li/Li⁺). When a material of which reaction potential is lower than that of Al (<+0.3 V vs Li/Li⁺) is used as the anode active material, it is concerned that the discharge properties are degraded as a result of occurrence of electrical insulation due to peel-off of the interface between the anode active material layer 4 when Al is damaged by the alloying reaction of Al with Li. In contrast, in the present disclosure, since the anode includes the anode active material layer, the intermediate layer, and the resin coating layer, or since the anode active material layer in the anode is the concentration gradient layer, the structure in which the electrolyte layer EL that is the moving path of Li ions does not directly contact with the anode current collector 3 is formed, and thereby Li ions are not present near the surface of the Al current collector, and it is possible to inhibit the alloying reaction of Al.

### 1. Anode

The anode in the present disclosure includes an anode current collector that is an Al current collector, and an anode active material layer containing an anode active material of which reaction potential is lower than the reaction potential of Al.

### (1) Anode Current Collector

The anode current collector in the present disclosure is an Al current collector. The Al current collector is a current collector using aluminum (Al) as a material. The Al current collector preferably contains Al as a main material. The Al current collector may be a simple substance of Al, and may be an Al alloy. In the Al alloy, the reaction potential of metal element other than Al is preferably lower than that of Al. The proportion of the Al element with respect to all the metal elements is, for example, 50 mol % or more, may be 70 mol % or more, and may be 90 mol % or more. Meanwhile, in the Al alloy, the proportion of the Al element with respect to all the metal elements is, for example, 99 mol % or less. Also, examples of the shape of the Al current collector may include a foil shape and a mesh shape. The thickness of the Al current collector is not particularly limited, and for example, it is 1 μm or more and 50 μm or less.

As shown in FIGS. 1A and 1B, the anode current collector 3 that is the Al current collector may be covered with the resin coating layer 5 containing a resin and a conductive material.

The resin coating layer contains a resin. Examples of the resin may include a thermoplastic resin, a thermosetting resin, and a conductive polymer. The thermoplastic resin is a resin that is soften by heating. The softening temperature of the thermoplastic resin is, for example, 100° C. or more and 200° C. or less, may be 110° C. or more and 190° C. or less, and may be 130° C. or more and 180° C. or less. Examples of the thermoplastic resin may include, poly(meth)acrylic acid, a poly(meth)methyl acrylate, polyethylene, polypropylene, polyethylene terephthalate, polyether nitrile, polyimide, polyamide, polytetrafluoroethylene, polyacrylonitrile, poly(meth)acrylate, and a halogenated vinyl resin. Incidentally, “(meth)acrylic acid” is a concept including both of acrylic acid and methacrylic acid, and “(meth)acrylate” is a concept including both of acrylate and methacrylate.

Examples of the thermosetting resin may include an epoxy resin, a vinyl ester resin, an unsaturated polyester resin, a phenol resin, and a melamine resin. The resin coating layer usually contains a cured product that is a cured thermosetting resin. Also, examples of the conductive polymer may include polyaniline, polypyrrole, polythiophene, polyacetylene, polyparaphenylene, polyphenylenevinylene, polyacrylonitrile, and polyoxadiazole. Also, the resin included in the resin coating layer may be one kind, and may be two kinds or more.

Above all, the resin included in the resin coating layer is preferably a thermoplastic resin. The reason therefor is that the thermoplastic resin is softened by heating, and thus, the intermediate layer can be easily formed by, for example, the later described pressing step. In particular, the resin coating layer preferably contains at least one kind of poly(meth)methyl acrylate, poly(meth)acrylate and polyacrylonitrile.

The resin may be a crystal resin, may be an amorphous resin, and may be a mixture of the both. From the viewpoint of adhesion, the resin is preferably the amorphous resin. Incidentally, “crystal” of the resin means that, when a differential scanning calorimetry measurement (DSC measurement) is conducted with a temperature rising speed of 10° C./min, the half-value width has an endothermic peak within 10° C. Meanwhile, “amorphous” of the resin means that the half-value width exceeds 10° C., or means that a clear endothermic peak is not confirmed.

The resin included in the resin coating layer may be the same resin as the binder included in the later described anode active material layer, and may be a different resin therefrom. Also, the resin included in the resin coating layer may not be a fluorine-containing resin such as PVdF.

The resin coating layer contains a conductive material. Examples of the conductive material may include a carbon material. Examples of the carbon material may include a particulate carbon material such as acetylene black (AB) and Ketjen black (KB), and a fiber carbon material such as carbon fiber, carbon nanotube (CNT), and carbon nanofiber (CNF). The proportion of the conductive material in the resin coating layer relative to resin 100 pts.wt. is, for example, 1 pts.wt. or more and 50 pts.wt. or less, may be 5 pts.wt. or more and 40 pts.wt. or less, and may be 10 pts.wt. or more and 30 pts.wt. or less. Also, the resin coating layer preferably does not contain the later described anode active material. Similarly, it is preferable that the resin coating layer does not contain the later described electrolyte, a solid electrolyte in particular.

The resin coating layer usually covers at least a surface (first surface) of the Al current collector that is the electrolyte layer side in a thickness direction. The resin coating layer may cover surfaces other than the first surface of the Al current collector. In a plan view from the thickness direction, the rate (coverage) of the part covered with the resin coating layer in the first surface is, for example, 50% or more, may be 70% or more, and may be 90% or more. Meanwhile, the coverage may be 100%, may be less than 100%, and may be 95% or less.

There are not particular limitations on the linear expansion coefficient of the resin coating layer, and for example, it is 100*10⁻⁶ ppm/K or more and 500*10⁻⁶ ppm/K or less, may be 200*10⁻⁶ ppm/K or more and 430*10⁻⁶ ppm/K or less, and may be 230*10⁻⁶ ppm/K or more and 350*10⁻⁶ ppm/K or less. The value of the linear expansion coefficient is a value measured by a method in accordance with JIS H7404-1993.

The thickness of the resin coating layer is not particularly limited, and for example, it is 0.5 μm or more, may be 1.0 μm or more, may be 3 μm or more, and may be 4 μm or more. Meanwhile, the thickness of the resin coating layer is, for example, 10 μm or less, may be 8 μm or less, and may be 6 μm or less.

### (2) Anode Active Material Layer

The anode active material layer contains an anode active material of which reaction potential is lower than that of Al.

The reaction potential of the anode active material is not particularly limited if it is lower than the reaction potential of Al, but based on Li, for example, it is 0.3 V (Li⁺/Li) or less, may be 0.2 V (Li⁺/Li) or less, and may be 0.1 V (Li⁺/Li) or less. Meanwhile, the reaction potential of the anode active material is, for example, −0.5 V (Li⁺/Li) or more. The reaction potential of the anode active material can be obtained by cyclic voltammetry (CV).

Examples of the anode active material may include a Si-based active material, a carbon-based active material, and a Li-based active material. The Si-based active material is an active material including a Si element. Examples of the Si-based active material may include a simple substance Si, a Si alloy and a Si oxide. The Si alloy preferably contains a Si element as a main component. The proportion of the Si element in the Si alloy is, for example, 50 mol % or more, may be 70 mol % or more, and may be 90 mol % or more. Meanwhile, the proportion of the Si element in the Si alloy is, for example, 99 mol % or less. Examples of the Si alloy may include a Si—Al-based alloy, a Si—Sn-based alloy, a Si—In-based alloy, a Si—Ag-based alloy, a Si—Pb-based alloy, a Si—Sb-based alloy, a Si—Bi-based alloy, a Si—Mg-based alloy, a Si—Ca-based alloy, a Si—Ge-based alloy, and a Si—Pb-based alloy. The Si alloy may be a two component alloy, and may be a multi component alloy of three components or more. Examples of the Si oxide may include SiO.

The carbon active material is an inorganic-based active material containing a C element, and examples thereof may include graphite, hard carbon, and soft carbon. Also, the Li-based active material is an active material containing a Li element, and examples thereof may include a simple substance of Li and a Li alloy.

Examples of the shape of the anode active material may include a granular shape and a layer shape. The average particle size (D₅₀) of the anode active material is, for example, 10 nm or more, and may be 100 nm or more. Meanwhile, the average particle size (D₅₀) of the anode active material is, for example, 50 μm or less, and may be 20 μm or less. The average particle size (D₅₀) refers to the particle size of 50% accumulation in the particle distribution on the volume basis by a laser diffraction particle distribution measurement device.

The anode active material layer may contain at least one of a conductive material, a binder, and an electrolyte, as required. Examples of the binder may include a rubber-based binder such as butadiene rubber (BR) and acrylate butadiene rubber (ABR) and styrene butadiene rubber (SBR), and a fluorine-containing binder such as polyvinylidene fluoride (PVDF) and polytetrafluoroethylene (PTFE). The conductive material is in the same contents as those described in “(1) Anode current collector” above. Meanwhile, the electrolyte is in the same contents as those described in “3. Electrolyte layer” later.

As shown in FIG. 2, the anode active material layer 4 is a layer containing a resin, and it may be a concentration gradient layer 7 of which concentration of the resin increases from the electrolyte layer EL towards the anode current collector 3 side. The resin is in the same contents as those described above.

As shown in FIG. 2, in the anode active material layer 4 (concentration gradient layer 7), the first surface Si is the surface opposite to the anode current collector 3 side, and the second surface S2 is the surface of the anode current collector 3 side. In this case, concentration C1 of the resin in the first surface S1 is smaller than concentration C2 of the resin in the second surface S2. The ratio of C1 with respect to C2, which is C1/C2 is, for example, 0.1 or more, may be 0.3 or more, and may be 0.5 or more. Meanwhile, the C1/C2 is, for example, 0.9 or less and may be 0.7 or less.

The concentration of the resin in the concentration gradient layer may continuously increase or stepwisely increase from the first surface S1 towards the second surface S2. Also, the second surface may contact the Al current collector, and may contact the resin coating layer covering the Al current collector. Also, when the second surface is observed from the thickness direction, the proportion of the resin in the concentration gradient layer is, for example, 80% or more and 100% or less, and may be 90% or more and 99% or less.

The thickness of the anode active material layer is not particularly limited, and for example, it is 0.5 μm or more and 1000 μm or less.

### (3) Intermediate Layer

The anode in the present disclosure may include an intermediate layer between the resin coating layer and the anode active material layer. Arrangement of the intermediate layer improves the adhesion of the resin coating layer and the anode active material layer. The intermediate layer contains the anode active material included in the anode active material layer, and the resin included in the resin coating layer. The intermediate layer is, typically a layer in which a part of the anode active material (one particle) included in the anode active material layer enters into the resin coating layer, and a part of the anode active material (one particle) is present with the constituent of the resin coating layer. For this reason, the intermediate layer may include a part of the conductive material (one particle) included in the resin coating layer. The anode active material, the resin, and the conductive material are respectively as described in “(1) Anode current collector” and “(2) Anode active material layer”.

In the cross-section of the intermediate layer, the rate of the resin with respect to the total rate of the anode active material and the resin is, for example, 10% or more and 90% or less. Also, in the intermediate layer, the rate of the resin may be uniform in the thickness direction. Meanwhile, the rate of the resin may change from the surface of the anode active material layer side towards the surface of the resin coating layer side in the intermediate layer. The rate of the resin may increase continuously or stepwisely, and may decrease continuously or stepwisely, but the former is preferable.

The rate of the thickness of the intermediate layer with respect to the total thickness of the anode active material layer, the intermediate layer, and the resin coating layer is, for example, 0.30% or more, may be 0.40% or more, may be 0.50% or more, may be 0.60% or more, may be 0.70% or more, may be 0.80% or more, may be 0.85% or more, may be 1.0% or more, and may be 1.5% or more. Meanwhile, the rate is, for example, 7.0% or less, may be 6.6% or less, may be 6.0% or less, may be 5.0% or less, and may be 3.0% or less.

The thickness of the intermediate layer is, for example, 10 nm or more, may be 30 nm or more, and may be 50 nm or more. Meanwhile, the thickness of the intermediate layer is, for example, 1000 nm (1 μm) or less, may be 800 nm or less, may be 600 nm or less, may be 400 nm or less, may be 300 nm or less, may be 200 nm or less, and may be 100 nm or less. The thickness of the intermediate layer is an average value of the thicknesses of arbitrary 10 points measured by observing the layer cross-section of the intermediate layer cut in the thickness direction, using a scanning electron microscope (SEM) with an energy dispersion X-ray spectrometer (EDX). Also, the components included in the intermediate layer can be confirmed by performing an EDX analysis to the chemical composition of the layer cross-section of the intermediate layer cut in the thickness direction, using a scanning electron microscope (SEM) with an energy dispersion X-ray spectrometer (EDX).

The method for forming the intermediate layer is not particularly limited, but for example, when the resin in the resin coating layer is a thermoplastic resin, an example is a method in which the resin coating layer and the anode active material layer are faced to each other and heated in that state so as to be a temperature more than the softening temperature of the thermoplastic resin, and then pressed. Meanwhile, when the resin in the resin coating layer is a thermosetting resin, an example is a method in which the thermosetting resin and the anode active material are filled in a mold to be heated and molded.

### 2. Cathode

The cathode in the present disclosure usually includes a cathode active material layer and a cathode current collector from the electrolyte layer side.

The cathode active material layer contains at least a cathode active material. The cathode active material layer may contain at least one of a conductive material, a binder, and an electrolyte, as required. The conductive material, the binder, and the electrolyte are in the same contents as those described in “1. Anode”.

Examples of the cathode active material may include an oxide active material. Examples of the oxide active material may include a rock salt bed type active material such as LiNi_{1/3}Co_{1/3}Mn_{1/3}O₂ and LiNi_{0.8}Co_{0.15}Al_{0.05}O₂; a spinel type active material such as LiMn₂O₄; and an olivine type active material such as LiFePO₄. Also, as the cathode active material, sulfur (S) may be used. Examples of the shape of the cathode active material may include a granular shape.

The thickness of the cathode active material layer is not particularly limited, but for example, it is 0.1 μm or more and 1000 μm or less.

The cathode current collector is a member that collects electrons of the cathode active material layer. The material for the cathode current collector is not particularly limited, and examples thereof may include SUS, aluminum, nickel, iron, titanium, and carbon. Examples of the shape of the cathode current collector may include a foil shape and a mesh shape.

### 3. Electrolyte Layer

The electrolyte layer is arranged between the cathode and the anode. In more specific, it is arranged between the cathode active material layer and the anode active material layer.

The electrolyte layer contains at least an electrolyte. Examples of the electrolyte may include a solid electrolyte. Examples of the solid electrolyte may include an inorganic solid electrolyte such as a sulfide solid electrolyte, an oxide solid electrolyte, and a halide solid electrolyte. The sulfide solid electrolyte preferably contains sulfur (S) as a main component of the anion element. The oxide solid electrolyte preferably contains oxygen (O) as a main component of the anion element. The halide solid electrolyte preferably contains halogen (X) as a main component of the anion. Among these, the sulfide solid electrolyte is preferable.

Examples of the sulfide solid electrolyte may include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (provided that m, n is a real number; Z is either one of Ge, Zn, and Ga), Li₂S—GeS₂, Li₂S—SiS₂—Li₃PO₄, and Li₂S—SiS₂-LiₓMO_{y} (provided that x, y is a real number; M is either one of P, Si, Ge, B, Al, Ga, and In).

Other examples of the solid electrolyte may include an organic solid electrolyte such as a polymer electrolyte and a gel electrolyte. Also, as the electrolyte, an electrolyte solution (liquid electrolyte) can also be used. Also, the electrolyte layer in the present disclosure may be a layer in which a separator is impregnated with a liquid electrolyte. The separator may be a conventionally known member.

In the present disclosure, the electrolyte layer containing a solid electrolyte may be referred to as a solid electrolyte layer, and a battery including the solid electrolyte layer may be referred to as an all solid state battery. Also, the electrolyte layer may contain a binder as required. The binder is in the same contents as those described in “1. Anode”. The thickness of the electrolyte layer is, for example, 1 μm or more and 500 μm or less.

### 4. Battery

The battery in the present disclosure may include an outer package for storing the above described members. Examples of the outer package may include a laminate type outer package and a case type outer package. Also, the battery in the present disclosure may include a restraining jig that applies a restraining pressure in the thickness direction to the above described members. As the restraining jig, known jigs may be used. The restraining pressure is, for example, 0.1 MPa or more and may be 50 MPa or less, and may be 1 MPa or more and 20 MPa or less.

The kind of the battery in the present disclosure is not particularly limited, but is typically a lithium ion secondary battery. Also, the battery is preferably an all solid state battery. The application of the battery is not particularly limited, and examples thereof may include a power source for vehicles such as hybrid electric vehicles (HEV), plug-in hybrid electric vehicles (PHEV), battery electric vehicles (BEV), gasoline-fueled automobiles and diesel powered automobiles. In particular, it is preferably used as a power source for driving hybrid electric vehicles (HEV), plug-in hybrid electric vehicles (PHEV), and battery electric vehicles (BEV). Also, the battery in the present disclosure may be used as a power source for moving bodies other than vehicles (such as rail road transportation, vessel and airplane), and may be used as a power source for electronic products such as information processing equipment.

### B. Method for Producing Battery

The present disclosure may also provide a method for producing the above described battery. In specific, it is possible to provide a method for producing the above described battery including the anode active material layer, the intermediate layer, and the anode current collector (Al current collector) covered with the resin coating layer, the method including: a layered body forming step of obtaining a layered body including layers in the order of the Al current collector, the resin coating layer, and the anode active material layer in a thickness direction; and a pressing step of applying a pressing pressure to the layered body in the thickness direction to form the intermediate layer.

In the layered body forming step, the resin coating layer may be formed by pasting a slurry containing a resin and a conductive material on the Al current collector and drying thereof. Also, the anode active material layer may be formed by pasting an anode slurry containing at least the anode active material on the resin coating layer and drying thereof. Also, the anode active material layer may be formed by using a transferring member including an anode active material layer and a substrate to transfer onto the resin coating layer.

The layered body may include just the anode active material layer, the resin coating layer, and the Al current collector. Also, the layered body may include an electrolyte layer, and may include an electrolyte layer and a cathode, on a surface of the anode current collector that is opposite side to the Al current collector.

The pressing step is not particularly limited as long as the intermediate layer can be formed by applying the pressing pressure to the layered body. The conditions for the pressing may be, for example, the conditions described in Examples. The pressing pressure may be applied once, and may be applied twice or more. Examples of the pressing method may include roll pressing and a cold isostatic pressing (CIP). The pressing pressure is, for example, 1 kN/cm or more and 100 kN/cm or less, and may be 5 kN/cm or more and 80 kN/cm or less. Also, in particular, when the resin is a thermoplastic resin, the pressing may be preferably performed while heating the layered body. The heating temperature is preferably set in consideration of the softening temperature of the thermoplastic resin, and for example, it is the softening temperature or more and the softening temperature+100° C. or less, and may be the softening temperature or more and the softening temperature +80° C. or less. Incidentally, the heating and the pressing may be performed simultaneously, and may be performed separately.

The present disclosure may also provide a method for producing the battery in which the above described anode active material layer is a concentration gradient layer, the method including a concentration gradient layer forming step of forming the concentration gradient layer on one surface of the Al current collector in a thickness direction. The concentration gradient layer forming step is not particularly limited as long as the above described concentration gradient layer can be formed.

The battery obtained by the above described step is in the same contents as those described in “A. Battery”.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### <Production of Cathode Side Layered Body>

A slurry including a sulfide solid electrolyte (SE: Li₂S—P₂S₅), a binder (acrylonitrile butadiene rubber (ABR)-based binder), and a dispersion medium (heptane and butyl butyrate) was agitated by ultrasonic dispersion apparatus to obtain a SE slurry. Here, the weight ratio of the SE and the ABR-based binder was adjusted to 99.4:0.6. The SE slurry was pasted on a substrate (Al foil) by a blade method and dried on a hot plate at 50° C. for 1 minute. After that, the product was further dried for 30 minutes on a hot plate at 150° C. Thereby, a transferring member including the substrate (Al foil) and the solid electrolyte layer (SE layer) was obtained.

Next, a slurry including a cathode active material (NCA: LiNi_{0.8}Co_{0.15}Al_{0.05}O₂), a sulfide solid electrolyte (SE: Li₂S—P₂S₅), a conductive material (vapor grown carbon fiber: VGCF), a binder (PVdF-based binder), and a dispersion medium (butyl butyrate) was agitated by ultrasonic dispersion apparatus to obtain a cathode slurry. Here, the weight ratio of the NCA, the SE, the VGCF, and the PVdF-based binder was adjusted to 78.3:18.8:2.9:2.8. This cathode slurry was pasted on a cathode current collector (Al foil) by a blade method, and dried on a hot plate at 50° C. for 20 minutes. After that, the product was further dried for 30 minutes on a hot plate at 150° C. Thereby, a cathode including a cathode current collector and a cathode active material layer was obtained.

The cathode and the transferring member were layered so that the cathode active material layer and the solid electrolyte layer were faced to each other. The product was pressed by a roll pressing machine at a pressure of 50 kN/cm at a temperature of 160° C. After that, the Al foil of the transferring member was peeled off, and punched out into a size of 1 cm². Thereby, a cathode side layered body including the cathode current collector, the cathode active material layer, and the solid electrolyte layer was obtained.

### <Production of Anode Side Layered Body>

A slurry including a sulfide solid electrolyte (SE: Li₂S—P₂S₅), a binder (acrylonitrile butadiene rubber (ABR)-based binder), and a dispersion medium (heptane and butyl butyrate) was agitated by ultrasonic dispersion apparatus to obtain a SE slurry. Here, the weight ratio of the SE and the ABR-based binder was adjusted to 99.4:0.6. The SE slurry was pasted on a substrate (Al foil) by a blade method and dried on a hot plate at 50° C. for 1 minute. After that, the product was further dried for 30 minutes on a hot plate at 150° C. Thereby, a transferring member including the substrate (Al foil) and the solid electrolyte layer (SE layer) was obtained.

A resin slurry containing a vinyl-based resin (methyl polymethacrylate), a conductive material (carbon), and a dispersion medium, was prepared. In the resin slurry, the weight ratio of the vinyl-based resin and the carbon was 4:1. This resin slurry was pasted on an Al foil by a blade method and dried on a hot plate at 50° C. for 20 minutes. After that, the product was further dried for 30 minutes on a hot plate at 150° C. Thereby, an anode member including an anode current collector (Al foil) and a resin coating layer was obtained. Also, the thickness of the anode member was measured by a micrometer, and the thickness of the resin coating layer was calculated by subtracting the thickness of the Al foil from the thickness of the anode member. The thickness of the resin coating layer was 2 μm.

Next, a slurry including an anode active material (silicon), a sulfide solid electrolyte (SE: Li₂S—P₂S₅), a conductive material (vapor grown carbon fiber: VGCF), a binder (PVdF-based binder), and a dispersion medium (butyl butyrate) was agitated by ultrasonic dispersion apparatus to obtain an anode slurry. Here, the weight ratio of the silicon: SE: VGCF: PVdF-based binder was adjusted to 49:41.2:7.5:6.6. This anode slurry was pasted on the resin coating layer by a blade method and dried on a hot plate at 50° C. for 20 minutes. After that, the product was further dried for 30 minutes on a hot plate at 150° C. Thereby, an anode including the anode current collector, the resin coating layer, and the anode active material layer was obtained.

The anode and the transferring member were layered so that the anode active material layer and the solid electrolyte layer faced to each other. The product was pressed by a roll pressing machine at a pressure of 50 kN/cm at a temperature of 160° C. After that, the Al foil of the transferring member was peeled off. Thereby, a layered body including the anode current collector, the resin coating layer, the anode active material layer, and the solid electrolyte layer was obtained. Next, the layered body and the transferring member were layered so that the solid electrolyte layers faced to each other. The product was provisionally pressed by a plane uniaxial pressing machine at 100 MPa and 25° C. After that, the Al foil of the transferring member was peeled off, and punched out into a size of 1.08 cm². Thereby, an anode side layered body was obtained.

### <Production of all Solid State Battery>

The cathode side layered body and the anode side layered body were layered so that the solid electrolyte layers faced to each other. The product was pressed by a plane uniaxial pressing machine at 200 MPa and 120° C. Thereby, a battery (all solid state battery) was produced.

### Example 2 and Example 3

A battery was produced in the same manner as in Example 1 except that the thickness of the resin coating layer in the anode member was respectively changed as shown in Table 1. Incidentally, the thickness of the resin coating layer was adjusted by changing GAP in the blade method.

### Example 4

First, a cathode was obtained in the same manner as in Example 1. The SE slurry produced in Example 1 was pasted twice on the cathode active material layer of the obtained cathode by a blade method. Thereby, a cathode side layered body including the cathode current collector, the cathode active material layer, and the solid electrolyte layer was obtained.

Next, an anode slurry was obtained in the same manner as in Example 1. The obtained anode slurry was pasted on a substrate (SUS foil) and dried. Thereby, a transferring member for anode including the SUS foil (substrate) and the anode active material layer was obtained.

The cathode side layered body and the transferring member for anode were layered so that the solid electrolyte layer and the anode active material layer faced to each other. The product was pressed by a roll pressing machine at 50 kN/cm and 160° C. After that, the SUS foil was peeled off to obtain a layered body. This layered body and the anode member produced in Example 2 were layered so that the anode active material layer and the resin coating layer faced to each other, and pressed by a plane uniaxial pressing machine at 500 Mpa and 160° C. Thereby, a battery was produced.

### Comparative Example 1

A battery was produced in the same manner as in Example 1 except that the resin coating layer was not arranged.

### [Evaluation 1]

### <Rate of Intermediate Layer>

The cross-section SEM images of the batteries produced in Examples 1 to 4 were obtained. In the observation of the SEM images, it was confirmed that the intermediate layer was formed in all Examples 1 to 4. Incidentally, in the observed intermediate layers, the proportion of the resin increased towards the Al foil. Also, the thickness of the anode active material layer, the thickness of the intermediate layer, and the thickness of the resin coating layer were measured based on the SEM images, and the rate (%) of the intermediate layer when the thickness from the anode mixture until the resin paste was regarded as 100 was calculated. As representative results, the rate of the intermediate layer in Example 2 was 6.6%, and the rate of the intermediate layer in Example 4 was 0.85%.

### <Cycle Test>

A cycle test was respectively conducted to the batteries produced in Examples 1 to 4 and Comparative Example 1 in the following manners, and the capacity durability was compared.

First, the battery was sandwiched between two pieces of restraining plates, and the two pieces of restraining plates were fastened by a fastener. Thereby, the distance between the two pieces of restraining plates was fixed.

Initial charge and discharge were conducted to the restrained battery in the following manners. First, constant current charge was conducted at 1/10 C until 4.05 V, and then constant voltage charge was conducted at 4.05 V until the terminal current of 1/100 C, and then constant current discharge was conducted at 1/10 C until 2.5 V, and finally, constant voltage discharge was conducted at 2.5 V until the terminal current of 1/100 C.

A cycle test was respectively conducted to the initial charged and discharged batteries in the conditions of temperature: 60° C., upper limit voltage: 3.96 V, lower limit voltage: 2.89 V, and 1/3 C. The capacity durability (%) was respectively calculated by dividing the capacity of the 30th cycle by the capacity of the first cycle. The result of Comparative Example 1 was set to 100, and the results were compared in relative values. The results are shown in Table 1.

TABLE 1

| | Thickness of resin | Capacity durability |
|---|---|---|
| | coating layer | (relative value) |
| Comp. Ex. 1 | 0 μm | 100 |
| Example 1 | 2 μm | 114 |
| Example 2 | 4 μm | 114 |
| Example 3 | 6 μm | 119 |
| Example 4 | 4 μm | 111 |

As shown in Table 1, the capacity durability of Examples 1 to 4 was respectively excellent compared to that of Comparative Example 1. Also, as shown in Examples 1 to 3, the thicker the resin coating layer, the better the capacity durability. Also, as shown in Example 2 and Example 4, the more the rate of the intermediate layer, the better the capacity durability.

The reason why the rate of the intermediate layer of Example 2 was larger than that of Example 4 was due to the production method of the battery. In specific, in Example 2, the pressing pressure was applied three times in the state the resin coating layer and the anode active material layer were in contact. On the other hand, in Example 4, the pressing pressure was applied once in the state the resin coating layer and the anode active material layer were in contact. For this reason, in Example 2, the rate of the intermediate layer was larger than that of Example 4 since the resin coating layer sank into the anode active material layer.

### Reference Example 1

A resin slurry containing a vinyl-based resin (methyl polymethacrylate), a conductive material (carbon), and a dispersion medium, was prepared. In the resin slurry, the weight ratio of the vinyl-based resin and the carbon was 4:1. This slurry was pasted on an Al foil by a blade method and dried on a hot plate at 50° C. for 20 minutes. After that, the product was further dried for 30 minutes on a hot plate at 150° C. Thereby, an anode member including an anode current collector (Al foil) and a resin coating layer was obtained. Also, the thickness of the anode member was measured by a micrometer, and the thickness of the resin coating layer was calculated by subtracting the thickness of the Al foil from the thickness of the anode member. The thickness of the resin coating layer was 3 μm.

The amount of 100 mg of a sulfide solid electrolyte (SE: Li₂S—P₂S₅) was put in a cylindrical container having a hole of φ11.28. After that, a SUS pin having φ11.28 was arranged and pressed at 100 MPa. After that, an anode member punched into 1 cm² was put on one side, and pressed at 600 MPa. Also, a Li foil punched into 1 cm² was arranged on the opposite side, and a SUS pin and a restraining jig were arranged in this order on each of the Al foil side and the Li foil side, restrained at 15 MPa, and thereby a half cell was obtained.

### Reference Example 2 and Reference Example 3

A half cell was respectively produced in the same manner as in Reference Example 1, except that the thickness of the resin coating layer in the anode member was changed as shown in Table 2. Incidentally, the thickness of the resin coating layer was adjusted by changing GAP in the blade method.

### Comparative Reference Example 1

A half cell was produced in the same manner as in Reference Example 1 except that the resin coating layer was not arranged.

### [Evaluation 2]

### <Cyclic Voltammetry Measurement>

A cyclic voltammetry (CV) measurement was respectively conducted to the half cells of Reference Examples 1 to 3 and Comparative Reference Example 1 using an electrochemical measurement device. The CV measurement was conducted in the condition of sweep rate: 0.5 mV/sec. The voltage was changed in the order of, from the initial voltage to 0 V, from 0 V to 2 V, and from 2 V to 0 V. In the second cycle, the maximum current value (maximum current value in the reduction side) flowed until 0 V was obtained. The results were relatively evaluated by setting the maximum current value in Comparative Reference Example 1 as 100. The results are shown in Table 2. Incidentally, the current observed in the CV measurement using the half cell is a current caused by the reaction of Al and Li.

TABLE 2

| | Thickness of resin | Maximum current value |
|---|---|---|
| | coating layer | (relative value) |
| Comp. Ref. Ex. 1 | 0 | 100 |
| Ref. Ex. 1 | 3 μm | 7.5 |
| Ref. Ex. 2 | 6 μm | 7.3 |
| Ref. Ex. 3 | 10 μm | 5 |

As shown in Table 2, the maximum current value of Reference Examples 1 to 3 was respectively remarkably lower than that of Reference Comparative Example 1, and it was confirmed that the reaction of the Al current collector and Li was remarkably inhibited. Also, from the results of Table 1 and Table 2, it was suggested that the similar effect was obtained when the anode active material layer was a layer containing a resin, and was a concentration gradient layer of which concentration of the resin increased from the electrolyte layer towards the anode current collector side.

### REFERENCE SINGS LIST

1 cathode current collector
2 cathode active material layer
3 anode current collector (Al current collector)
4 anode active material layer
5 resin coating layer
6 intermediate layer
7 concentration gradient layer
CA cathode
AN anode
EL electrolyte layer
10 battery

What is claimed is:

1. A battery comprising a cathode, an anode, and an electrolyte layer arranged between the cathode and the anode, wherein
the anode includes an anode current collector that is an Al current collector, and an anode active material layer containing an anode active material of which reaction potential is lower than the reaction potential of Al; and
the anode current collector is covered with a resin coating layer containing a resin and a conductive material, and further, an intermediate layer containing the resin and the anode active material is arranged between the resin coating layer and the anode active material layer.

2. A battery comprising a cathode, an anode, and an electrolyte layer arranged between the cathode and the anode, wherein
the anode includes an anode current collector that is an Al current collector, and an anode active material layer containing an anode active material of which reaction potential is lower than the reaction potential of Al; and
the anode active material layer is a layer containing a resin, and is a concentration gradient layer of which concentration of the resin increases from the electrolyte layer towards the anode current collector side.

3. The battery according to claim 1, wherein the resin is a thermoplastic resin.

4. The battery according to claim 1, wherein a reaction potential of the anode active material is 0.3 V (Li⁺/Li) or less.

5. The battery according to claim 1, comprising a Si-based active material or a carbon-based active material as the anode active material.

6. The battery according to claim 5, comprising the Si-based active material as the anode active material.

7. The battery according to claim 1, wherein the electrolyte layer is a solid electrolyte layer containing a solid electrolyte.

8. The battery according to claim 1, wherein the resin coating layer does not contain the anode active material.

9. The battery according to claim 1, wherein a rate of a thickness of the intermediate layer with respect to a total thickness of the anode active material layer, the intermediate layer and the resin coating layer is 0.80% or more.

10. The battery according to claim 1, wherein a rate of a thickness of the intermediate layer with respect to a total thickness of the anode active material layer, the intermediate layer and the resin coating layer is 7.0% or less.

11. The battery according to claim 1, wherein a thickness of the resin coating layer is 10 μm or less.

12. A method for producing the battery according to claim 1, the method comprising:
a layered body forming step of obtaining a layered body including layers in the order of the Al current collector, the resin coating layer, and the anode active material layer in a thickness direction; and
a pressing step of applying a pressing pressure to the layered body in the thickness direction to form the intermediate layer.

13. A method for producing the battery according to claim 2, the method comprising:
a concentration gradient layer forming step of forming the concentration gradient layer on one surface of the Al current collector in a thickness direction.
